(19) United States
(12) Patent Application Publication
(10) Pub. No.: US 2026/0197517 A1
(43) Pub. Date: Jul. 9, 2026

(54) AUTOMATED MUTLI-MODAL SENSING SYNCHRONIZATION

(71) Applicant: SEMICONDUCTOR COMPONENTS INDUSTRIES, LLC, Scottsdale, AZ (US)

(72) Inventors: Devon M. JOHNSON, Westfield, IN (US); Christopher D. SILSBY, Corvallis, OR (US); Brenden Taylor HATTON, Corvallis, OR (US)

(73) Assignee: SEMICONDUCTOR COMPONENTS INDUSTRIES, LLC, Scottsdale, AZ (US)

(21) Appl. No.: 19/010,521

(22) Filed: Jan. 6, 2025

(51) Int. Cl. H04N 21/43; H04N 21/422; H04N 21/4223

(52) U.S. Cl. CPC H04N 21/4307; H04N 21/42203; H04N 21/4223

(57) ABSTRACT

Systems, devices, and methods are described to synchronize sensor data from multiple sensor devices without the use of additional reference clocks, time stamps, or the like. An image sensor may generate image data and receive sensor data from an external sensor, and may include an output circuit and memory for storing received external sensor data. The output circuit may retrieve a first external sensor data from memory in response to an acquisition signal. The first sensor data may include pre-sampling data received prior to the acquisition signal. The output circuit may acquire image data in synchronization with the acquisition signal, and may retrieve a second external sensor data from memory. The second external sensor data may include post-sampling data received during sampling of the image data. The output circuit may provide the first external sensor data, the image data, and the second external sensor data as a combined output.

### BACKGROUND

This application relates generally to image sensors and, more particularly, to combining and transmitting image sensor data with external or otherwise auxiliary sensor data such that the external or otherwise auxiliary sensor data is synchronized with the image sensor data.

In the automotive industry, vehicles often have one or more cameras placed internal and/or external to vehicle. These cameras may be used for backup, forward vision, Advanced Driver Assistance Systems (ADAS), surround-view, e-mirror, in-cabin monitoring, and the like. Independently, audio systems such as in-car infotainment, radio, cell phone connections, and the like have microphone arrays to facilitate phone calls, hands-free commands, monitor sound levels, and more recently detect noises both inside and outside of the vehicle. Currently, systems which align such microphones with each other and with video data do not exist. Rather, current systems use inherently unsynchronized audio and video using independent encoders, and do not provide flexibility in the sampling frequency of the audio and video data.

Video and audio streams can be paired and synchronized for presentation together. In general, synchronizing audio and video assumes separate encoding systems that are linked together with a master time clock. In MPEG2, for example, a System Time Clock (STC) is generated independently from audio and video encoders and serves as a master reference for the system. Audio and video data are then each individually timestamped with a Presentation Time Stamp (PTS) which tells the decoding system when to output video and audio data respectively. Other standards may be required to carry an accurate clock reference in order to be compatible with multiple audio/video processing systems.

Therefore, combining audio and video streams may currently involve two separate systems, operating in two independent domains, sharing a master clock signal that is then inserted into the streams to synchronize or match the time coding of the audio stream to the time coding of the video stream. Exemplary encoding systems and codecs may include MPEG 1 (DVD), MPEG 2 (ATSC for HD Television), and MPEG 4 (audio/video streaming). Such encoding systems and methods can be prohibitively complicated and are often not feasible in limited processing environments such as vehicles.

It would therefore be desirable to provide improved systems, devices, and methods for providing external sensor data synchronized with image sensor data.

### BRIEF DESCRIPTION OF DRAWING FIGURES

FIG. 1 is a block diagram of an exemplary image sensor, according to various embodiments.

FIG. 2 representatively illustrates a first arrangement of combined sensor data, according to various embodiments.

FIG. 3 representatively illustrates a second arrangement of combined sensor data, according to various embodiments.

FIG. 4 is a flowchart illustrating an exemplary method for synchronizing multi-sensor output, according to various embodiments.

FIG. 5 is a block diagram of an exemplary multi-sensor system, according to various embodiments.

### BRIEF SUMMARY

Various embodiments relate to systems, devices, and methods for combining image sensor data with external or otherwise auxiliary sensor data.

In various embodiments, a method for synchronizing multi-sensor output may include sampling, by a first sensor device, a first sensor data; receiving, by the first sensor device, a second sensor data from a second sensor device prior to the sampling of the first sensor data; receiving, by the first sensor device, a third sensor data from the second sensor device during the sampling of the first sensor data; creating, by the first sensor device, an associated sensor data, comprising associating the first sensor data with the second sensor data and the third sensor data; and outputting, by the first sensor device, the associated sensor data.

In various embodiments, an image sensor may include a pixel array adapted to generate an image data; an input adapted to receive a plurality of sensor data from a second sensor device; a memory adapted to store at least some of the plurality of received sensor data; and an output circuitry adapted to: retrieve a first sensor data from the memory in response to an acquisition signal, wherein the first sensor data is received from the second sensor device prior to the acquisition signal; acquire the image data in synchronization with the acquisition signal; retrieve a second sensor data from the memory, wherein the second sensor data is received from the second sensor device while acquiring the image data; and transmit the first sensor data, the image data, and the second sensor data, comprising: identifying the first sensor data as a pre-sampling sensor data; and identifying the second sensor data as a post-sampling sensor data.

In various embodiments, a sensor device may include a sensing apparatus adapted to periodically generate a first sensor data based on received stimuli; an input adapted to receive a plurality of second sensor data from an external sensor device; a memory adapted to store the received second sensor data; and an output circuitry adapted to: retrieve a first set of the plurality of second sensor data from the memory in response to a periodic generation of the first sensor data, wherein the first set is received from the external sensor device prior to the periodic generation; retrieve a second set of the plurality of second sensor data from the memory, wherein the second set is received from the external sensor device during the periodic generation; and transmit an associated sensor data comprising the first set of second sensor data, the generated first sensor data, and the second set of second sensor data.

These and other examples are described in increasing detail below.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, externally sensed audio data may be integrated into and synchronized with a video stream in an efficient manner. By including the audio information from an external sensor which is captured in a buffer inside the image sensor, it is possible to greatly simplify the interface complexity which feeds a System on Chip (SoC) or other application processor. Audio may be synchronized to video in an accurate manner which facilitates decision making processes for autonomous vehicles and automotive information systems such as Advanced Driver Assistance Systems (ADAS), Sentry Mode Security Systems, and/or Autonomous Driving (AD). For example, audio may time synchronized with video by packetizing inside of the video stream as embedded data or along with the transmitted video frames in a virtual channel.

According to various embodiments described herein, it is possible, without much additional overhead in image sensor design, to set up the image sensor to acquire audio (or other external sensor data) and embed it within the video transport such that the audio is synchronized with video. For example, in a surround-view application, representative image sensors may synchronize multiple (e.g., 4) external microphones to each other and/or to one or more video streams, enabling enhanced sensing capability with the benefit of audio synchronized to video. For example, various surround-view applications may synchronize multiple video streams, and synchronizing each audio stream to a same or separate video stream therefore provides synchronized audio.

According to various embodiments, systems and methods provide audio synchronized to video. Various embodiments may provide multi-camera audio synchronization, for example when the multi-camera system uses a common trigger signal such as in the case of surround-view systems. This allows for more detailed audio array analysis, such as phase analysis in addition to amplitude analysis. With knowledge of the placement of the cameras and/or microphones, this can be used for determining and locating sources of sounds, such as sirens, honking car horns, for situational awareness such as determining a “walk” sound at a cross-walk, road hazard noise (e.g., rumbling from tires or pot holes), or vehicle degradation such as flat tire, bad suspension, CV joint wear, and/or the like.

In various embodiments, an image sensor outputs a clock signal to an external or otherwise auxiliary sensor such as a microphone and responsively receives and stores audio data into a memory (e.g., FIFO) which is coupled with an image framer device. The image framer reads the stored audio data, as pre-sampling data, synchronized with an external trigger or an internally generated valid signal. Once the image sampling begins, post-sampling audio may be received and stored at the end of lines (pixel rows) or at end of image frame.

The technology described herein eliminates the need for timestamping because the audio is integrally synchronized to the video data due to co-packetization with the video data and may be further aligned by buffer separation with respect to the one or more internal valid signals. Accordingly, embodiments according to the description herein provide extremely tightly coupled data, helping with on-chip buffering strategy and minimizing the amount of additional memory required. No extra clock information need be provided in the stream, reducing the need for any control packets or phase information. Further, raw audio data, rather than decimated and processed audio, may be included in the video stream. Systems and methods described herein may be applied in any autonomous or semi-autonomous platform using any relevant sensor modality, such as with ADAS, Automotive AD, Automotive Surround-View, Industrial Robotics, Ultrasonic Distance Integration, and/or the like.

The technology described herein is illustrated with respect to image sensors. The embodiments describe herein may be applied to any suitable configurations of image sensors, pixel arrays, pixels, and the like. For example, suitable configurations may include 1D and 2D image sensors, CMOS image sensors, CCD image sensors, stacked image sensors, visible light sensors, infrared (IR) or near-IR sensors, light detection and ranging (LiDAR) sensors, contact sensors, time-of-flight (ToF) sensors, silicon photomultipliers (SiPM), may use global and/or rolling shutter, and the like.

It will be recognized that the systems and methods described herein may be applied to sensing devices and modalities other than image sensors. Embodiments according to the present technology may combine different sensor modalities, for example sensors that observe different environmental stimuli, sensors that measure different forms of energy, and the like, and may synchronize the outputs of such sensors without the need for time stamps, reference clocks, or the like. The present technology may also be extended to combine sensor data for similar or the same type of sensor devices. Embodiments according to the present technology greatly simplify the interface complexity which feeds downstream systems.

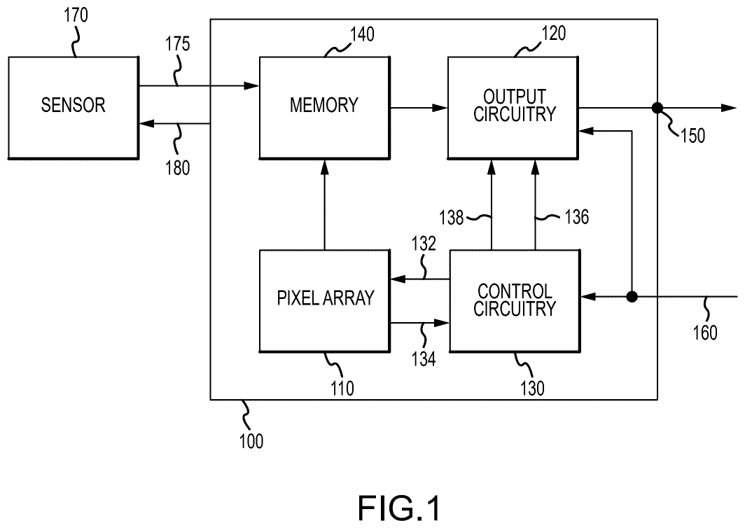

FIG. 1 illustrates a block diagram of an exemplary image sensor 100. In some embodiments, the image sensor 100 may include a pixel array 110 having one or more image sensor pixels (not shown). The pixels may be arranged in any suitable manner. For example, the pixels may be arranged in groups, for example in a stacked sensor arrangement. In some embodiments, the pixels of the pixel array 110 may be arranged in rows and columns. In some embodiments, the pixel array 110 may be read out row-by-row, for example one pixel row at a time or overlapped and/or staggered pixel row readout. The image sensor 100 may also include an output circuitry 120, a control and processing circuitry 130, and a memory 140.

The control and processing circuitry 130 may also be referred to herein as control circuitry 130, and may include any suitable devices or processes adapted to perform the functions described herein. The control circuitry 130 may provide timing controls 132 for the pixel array 110. Based on the timing controls 132, the control circuitry 130 may control the pixel array 110 to capture, sample, or otherwise acquire image data. For example, the control circuitry 130 may provide timing controls 132 configured to cause one or more pixels of the pixel array 110 to be reset, to convert the incoming light to generate a corresponding electrical charge during an integration period, to sample the generated charge and/or reset levels, to perform multi-gain readout of the pixels, and/or the like.

The control circuitry 130 may also perform processing of the pixel data 134 read out from the pixel array 110. For example, the control circuitry 130 may perform amplification, analog-to-digital conversion (ADC), dynamic range adjustment such as high dynamic range (HDR) processing, and/or the like.

The control circuitry 130 may be configured to output image data 136 based on an image captured by the image sensor 100. The image data 136 may include information, such as binary representations of the values of each of the pixels of the pixel array 110, captured by the image sensor 100 at a particular point in time or over a particular period of time. For example, after performing processing the control circuitry 130 may output a binary representation, such as a 12-bit or 14-bit value, of the charge generated by each pixel of the pixel array 110 during an integration period. The image data 136 may be arranged in any suitable manner, for example corresponding to the manner in which the pixel array 110 is read out by the control circuitry 130.

In some embodiments, the image data 136 may include multiple rows of pixel data, with each row including a pixel value (e.g., binary representation) for each of the pixels in the corresponding pixel row of the pixel array 110. A pixel row may be referred to as a row herein. In some embodiments, the control circuitry 130 may include memory (not shown) configured to temporarily store some or all image data 136 prior to output. For example, the control circuitry 130 may include output buffer configured to store one or more rows of the image data 136. In some embodiments, the image data may be stored in a shared memory, for example in the memory 140.

In some embodiments, the control circuitry 130 may provide a valid signal 138 indicating that some portion of image data 136, such as a pixel row, subsection, and/or the entire pixel array 110 has completed readout and processing and is ready for output. For example, the control circuitry 130 may provide a line valid signal when the control circuitry 130 has completed processing of a pixel row and stored corresponding image data in a memory, such as the memory 140 or a memory of the control circuitry 130, or may provide a frame valid signal when the entire image data for the pixel array 110 has been processed and corresponding image data is stored in such a memory, and/or the like.

In some embodiments, the control circuitry 130 may provide the respective valid signal(s) 138 when the respective data is beginning to be prepared. For example, the control circuitry 130 may provide a line valid signal when a pixel row is being reset, integrated, read out from the pixel array 110, and/or the like, and/or may provide a frame valid signal when the pixel array 110 begins reset operations, begins integration, begins pixel readout, and/or the like. The valid signal 138 may therefore be provided, in various embodiments, when the image data acquisition begins, at a predetermined step during the image data acquisition, and/or when image data acquisition has completed.

In some embodiments, the image sensor 100 may include an input configured to receive an external trigger 160 signal. For example, in multi-camera systems such as in automotive surround-view applications, a trigger 160 may be provided to each of multiple image sensors 100 to synchronize the simultaneous capture of images from each of the multiple image sensors 100. The trigger 160 may enable an accurate and real-time view to be created from multiple image sensors 100.

In some embodiments, the control circuitry 130 may receive the trigger 160 and may control capture and/or output of image data in synchronization with the trigger 160. In some embodiments, the control circuitry 130 may initiate image capture, such as starting reset, integration, and pixel readout, upon receiving a trigger 160 signal. In some embodiments, the control circuitry 130 may output an already-generated image data upon receiving a trigger. For example, the pixel array 110 may be operated to continuously capture image data, and the control circuitry 130 may output the most recently acquired image data upon receiving the trigger 160.

More generally, the image sensor 100 may sample image data (whether for a pixel row, the entire pixel array 110, or the like) in synchronization with an acquisition signal. The acquisition signal and the sampling of image data may be associated and proximate in time. The acquisition signal may be at a known or knowable point in time, whether absolute or relative (e.g., offset), with respect to the process of sampling the image data. In some embodiments, the acquisition signal may be provided in response to a status of obtaining or otherwise determining the sensor data. In some embodiments, the sensor data may be captured, processed, stored, or the like in response to receiving the acquisition signal. It will be recognized that the systems and methods of the present disclosure may be applied with multiple acquisition signals, for example with relation to multiple line valid signals.

The acquisition signal may be the trigger 160, may be the valid signal(s) 138 from the control circuitry 130, or any other suitable indicia of timing with respect to the sensor data. In some embodiments, sampling the image data may include initiation of the capture of image data, such as starting the reset, integration, readout of the pixel array 110, and/or output of a post-processing pipeline. In some embodiments, sampling the image data may include storing already-processed pixel data for readout, making already-captured image data ready for output, or otherwise providing a portion (e.g., line by line) or all of the image data.

In some embodiments, the control circuitry 130 may control the pixel array 110 to periodically provide a full frame of image data, such as at a regular interval, at a known frequency, based on a regular or otherwise repeating hardware or software interrupt, or the like. For example, the control circuitry 130 may operate the pixel array 110 at a predetermined frequency, such as 10 frames per second (FPS), 24 FPS, 30 FPS, 100 FPS, or the like. For further example, the control circuitry 130 may control the pixel array 110 to provide a full frame of image data based on the trigger 160. The periodicity may be fixed, for example at a fixed framerate, or may be variable at knowable time intervals, or the like.

In some embodiments, the image sensor 100 may be adapted for communicative coupling with one or more external or otherwise auxiliary sensor devices 170 (hereinafter external sensor device 170). The image sensor 100 may include an input couplable with the external sensor 170 and adapted to receive external sensor data 175 from the external sensor 170. While various embodiments illustrated herein refer to an external sensor 170 and external sensor data 175, it will be understood that the image sensor 100 may equivalently include the external sensor 170 as an auxiliary sensor, for example within the image sensor 100, and the external sensor data 175 may include data from such an auxiliary sensor. Further, any suitable primary sensor may be used in place of an image sensor 100. In some embodiments, the image sensor 100 may include an output couplable with the external sensor 170 and adapted to provide a control signal according to which the external sensor 170 generates the external sensor data 175 based on stimuli received by the external sensor 170. In some embodiments, the control signal may include a clock signal 180. In some embodiments, the input and output may be general purpose input/output (GPIO) pins of the image sensor 100.

The external sensor 170 may include any suitable sensing apparatus, for example an auditory sensor, a gyroscope, an accelerometer, ultrasonic sensor, or the like. For example, in some embodiments, the external sensor 170 may include an ultrasonic sensor and the external sensor data 175 may include distance information. In some embodiments, the external sensor 170 may include an auditory sensor such as a microphone and the external sensor data 175 may include audio data.

For example, the external sensor 170 may include a pulse density modulation (PDM) microphone. The clock 180 may be selected or otherwise controlled by the image sensor 100 at any suitable frequency. The image sensor 100 may be programmed to create, for example, a clock 180 signal over the range of 500 kHz to 5 MHz, for example accommodating low power operation (500 kHz), high quality microphone operation (3 MHZ), and ultrasonic operation (5 MHz). It will be recognized that any suitable frequency may be used.

The frequencies selected by the image sensor 100 may be static frequencies or dynamically programmed frequencies, for example using an N/M multiplier/divider (also referred to as a fractional-N synthesizer). The exemplary PDM microphone may provide, as the external sensor data 175, a square wave output synchronized with the clock 180. The image sensor 100 input receiving the external sensor data 175 may also be sampled using the clock 180 reference, which may eliminate the need for oversampling and reduce the amount of data required. The square wave output may comprise a single-bit data (logic 0 or 1) for each cycle of the clock 180.

The image sensor 100 may store the received external sensor data 175 in the memory 140. The memory 140 may include any suitable memory type and/or configuration. In some embodiments, the memory 140 includes a first-in first-out (FIFO) buffer. In some embodiments, the memory 140 may be shared with other components of the image sensor 100, for example a frame buffer adapted to be shared storage for the external sensor data 175 and the image data.

In some embodiments, because the external sensor data 175 may be synchronously generated by using the clock 180, the image sensor 100 may straightforwardly read the external sensor data 175 into a frame buffer memory 140. As noted, the frame buffer may be dedicated only to audio data, or may be adapted to be shared with the image data processing. In some embodiments, the audio data is a continuous signal where disruptions may be easily detected, and therefore the buffer memory 140 may be continuously available for receiving the audio data. In some embodiments, the memory 140 may be a shared memory between the audio and video processing may be dynamically allocated depending on the need of the image sensor 100 at the time. For example, the image sensor 100 may use more memory 140 for audio buffer during the blanking time, and may use less audio buffer during the integration and redout of the pixel array 110. Advantageously, in some embodiments, an audio data buffer may be implemented with little or no additional buffer memory added to existing image sensor designs.

In some embodiments, the image sensor 100 may be adapted to provide, on a sensor output 150, a combined output of image data and external sensor data 175. In some embodiments, the combined output may be determined and provided by the output circuitry 120. The combined output may include the external sensor data 175 arranged with the image data such that the received external sensor data 175 is associated with the image data without creating or using separate timestamps, master clock, or other timing tags. The combined output may therefore be referred to herein as associated sensor data. The combined output may be receivable by another component, processor, system, or the like, which is configured to extract the external sensor data 175 and the image data such that the external sensor data 175 remains synchronized with the image data.

The output circuitry 120 may include any suitable devices and/or processes adapted to arrange or otherwise prepare the associated sensor data for transmission from the image sensor 100. The output circuitry 120 may transmit the associated sensor data via the sensor output 150. The output circuitry 120 may be adapted to receive the acquisition signal, for example coupled with the valid signal 138 and/or the trigger 160. The output circuitry 120 may be coupled with the memory 140 for obtaining the received external sensor data 175. The output circuitry 120 may be coupled with the control circuitry 130 and/or pixel array 110 for obtaining the image data.

In some embodiments, the output circuitry 120 may include a framer device, which may be a device or circuit that specifically formats and generates data streams according to a predetermined protocol. In some embodiments, the framer device may be an image framer, for example adapted to format and generate data streams according to the MIPI® Alliance Camera Serial Interface 2 (CSI-2®) protocol. Some such protocols may structure image data into packets ready for transmission over the sensor output 150, for example a MIPI® interface. Some embodiments may send data packets using a virtual channel, which may separate individual data streams within one output interface.

In some embodiments, the output circuitry 120 may include a serializer/de-serializer (SERDES) device, which may include an integrated circuit (IC) transceiver configured to convert parallel data to serial data and/or vice versa. For example, the output circuitry 120 may include a physical layer according to the MIPI® A-PHY® specification. For further example, the output circuitry 120 may include circuitry adapted to provide the image data according to an Automotive SerDes Alliance (ASA) standard. Any suitable communication standards, interfaces, protocols, and/or the like may be implemented by the output circuitry 120 and sensor output 150.

The output circuitry 120 may be configured to prepare and transmit the image data as a still image and/or as a stream of video images. The prepared image data may be referred to as an image frame or a video frame. The image frame or video frame may include additional information as desired, for example metadata. A video stream may be output at a predetermined frequency, framerate, or the like. The output circuitry 120 may be adapted to include and/or transmit the external sensor data 175 with the image frame, for example incorporated into the image frame or transmitted as a grouping of data packets.

In some embodiments, the associated sensor data may be generated by separately identifying (1) the external sensor data 175 that is received prior to sampling the image data, which may be referred to herein as pre-sampling data, and (2) the external sensor data 175 that is received during and/or after sampling the image data, which may be referred to herein as post-sampling data. For example, the pre-sampling data may include external sensor data 175 that is received prior to the output circuitry 120 receiving the acquisition signal, and post-sampling data may include external sensor data 175 that is received during and/or after the output circuitry 120 receives the acquisition signal. The pre-sampling data and post-sampling data are therefore each associated with the image data with respect to the time of sampling the image data. The pre-sampling data and post-sampling data are also each associated with the image data with respect to the acquisition signal due to the synchronization of the acquisition signal and the image data sampling. Other embodiments may include a pre-sampling data as the external sensor data 175 received during sampling of the primary sensor data, and may include a post-sampling data as the external sensor data 175 received after sampling of the primary sensor data. In all such cases, the pre-sampling data and post-sampling data may be associated with the primary sensor data with respect to the acquisition signal and/or sampling of primary sensor data.

In some embodiments, the output circuitry 120 may be configured to packetize the external sensor data 175 and the image data, for example for transmission in a virtual channel. Each of the respective packets may include information, for example in a header or footer, identifying the type of data (e.g., image data or external sensor data 175) and its relation to the image data being sent (e.g., pre-sampling data, image data, or post-sampling data). From this identifying information, a receiving device may reconstruct the external sensor data 175, for example audio data, and synchronize it with the image data without any additional time stamps, time stamp circuitry, reference clocks, or the like.

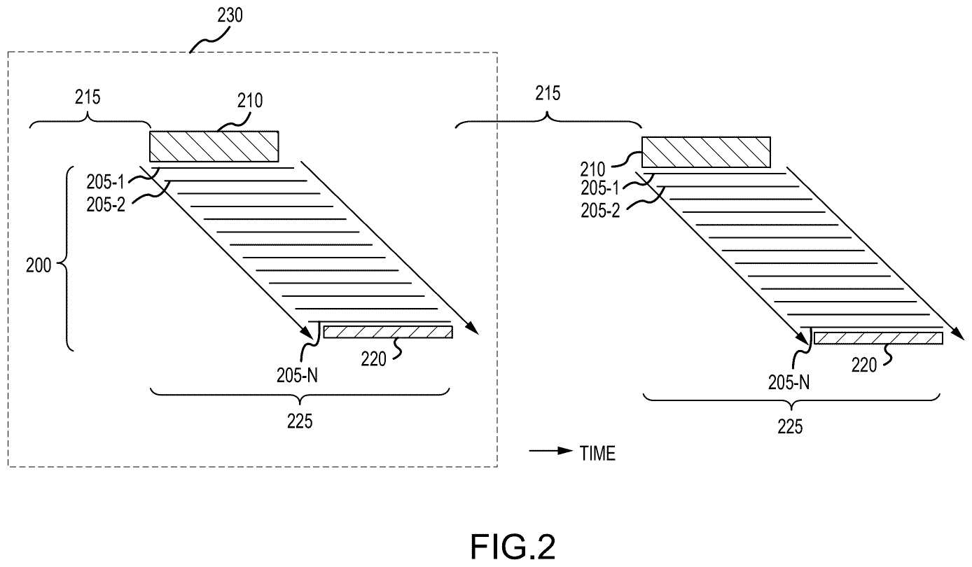

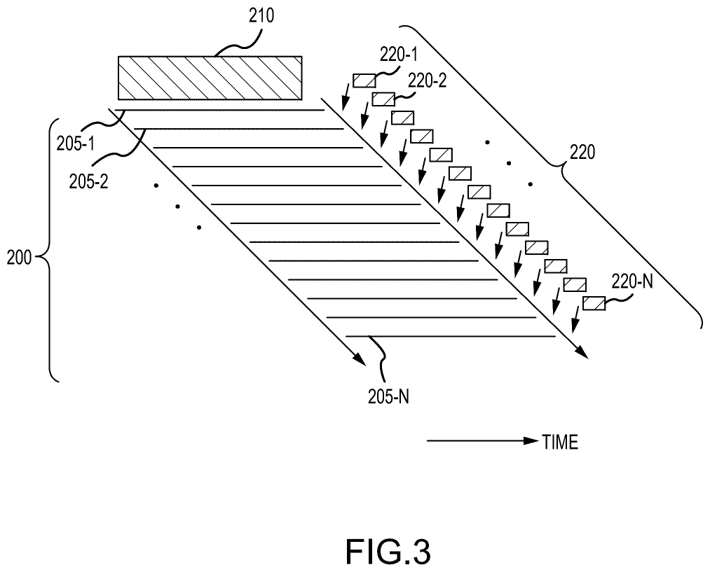

Referring to FIGS. 2 and 3, in some embodiments, the output circuitry 120 may be configured to combine the image data 200 with the pre-sampling data 210 and the post-sampling data 220 within the image frame 230 prepared and transmitted by the output circuitry 120. For example, the image sensor 100 may accumulate 215 a first portion of external sensor data 175, such as audio data, in the memory 140. In some embodiments, the output circuitry 120 may obtain the first accumulated portion 215 of external sensor data 175 from the memory 140 in response to receiving an acquisition signal. The output circuitry 120 may insert this first accumulated portion 215 at or near the beginning of the image frame 230, for example prior to the image data 200. The image sensor 100 may immediately begin accumulating 225 a second portion of external sensor data 175 in the memory 140.

The image sensor 100 may begin acquiring image data 200 in synchronization with the acquisition signal. In some embodiments, the pixel array 110 may be controlled to acquire one or more pixel rows 205-1, 205-2, . . . , 205-N of data in a rolling shutter mode, where each row has a reset and integration period offset in time from adjacent rows. During the sampling of image data 200, the image sensor 100 may continue accumulating the second portion 225 of external sensor data 175 in the memory 140. At the end of sampling image data 200, for example when the last pixel row 205-N is acquired, the output circuitry 120 may obtain the second accumulated portion 225 of external sensor data 175 from the memory 140. The output circuitry 120 may insert the second accumulated portion 225 at or near the end of the image frame 230, for example after the image data 200.

The position of the first accumulated portion 215 at the beginning of the image frame 230 or otherwise prior to the image data 200 may identify it as the pre-sampling data 210. The position of the second accumulated portion 225 at the end of the image frame 230 or otherwise after the image data 200 may identify it as the post-sampling data 220. Other suitable arrangements of the first accumulated portion 215, image data 200, and second accumulated portion 225 within the image frame 230 may be used to identify the pre-sampling data 210 and post-sampling data 220.

In some embodiments, the pre-sampling data 210 and post-sampling data 220 may be included in the image frame 230 in a similar or same format as the pixel rows 205, for example stored as one or more rows of pixel data. By formatting the pre-sampling data 210 and post-sampling data 220 as image data, the output circuitry 120 may use the same output buffers or other circuitry for providing the associated sensor data. In some embodiments, the output circuitry 120 may begin providing the image frame 230 data over the sensor output 150 as it becomes ready, for example row by row. Memory requirements may be reduced in such embodiments.

In an illustrative embodiment, at a video framerate of approximately 30 FPS each image frame 230 occupies approximately 33 ms in time including time required for sampling image data 200 and dormant time between subsequent image data 200 samplings. The post-sampling data 220 may correspond to the external sensor data 175 received during the time required for sampling image data 200 and the pre-sampling data 210 may correspond to external sensor data 175 received during the dormant time. In some embodiments, for an initial condition such as for the first image frame 230 of a video stream, the output circuitry 120 may not include any pre-sampling data 210 because it may be of an unknown size or may not have been stored in the memory 140. The image sensor 100 may then start accumulating pre-sampling data 210 for the next image frame.

In this example, if the time required for sampling image data 200 is approximately 7.7 ms, a pixel row comprises a plurality of pixel data encoded at 12 bits per pixel, and the post-sampling data 220 comprises a plurality of bits corresponding to the received PDM microphone data, then the post-sampling data 220 for an image frame 230 may occupy approximately one full row of embedded data. The pre-sampling data 210 may then include accumulation of PDM data for the prior 25.3 ms and may occupy approximately 3.3 rows of embedded data. For further example, if the PDM microphone is clocked at 2 MHz (incoming data rate of 2 Mbps), the row time is approximately 7 μs, then the pre-sampling data 210 accumulated during the blanking time of 25.3 ms will include about 50,600 bits of PDM samples, which will occupy approximately 4,217 pixels of data at 12 bits per pixel. A pixel row may commonly range from 1080, 1920, 3840, or more pixels, and therefore the pre-sampling data 210 may occupy one to five pixel rows of data depending on pixel array 110 implementation.

In various embodiments, the first accumulated portion 215 and second accumulated portion 225 of external sensor data 175 may sum to be the entire amount of external sensor data 175 received by the image sensor prior to (e.g., between image frames, during the dormant time) and during sampling of an image data 200. The first accumulated portion 215 and second accumulated portion 225 may sum to be the entire amount of external sensor data 175 received while the image sensor 100 provides a series of image frames such as a video stream. The point in time, for example in relation to the acquisition signal, in relation to image data sampling, or the like, where the first accumulated portion 215 ends and the second accumulated portion 225 begins may be adjusted as desired.

In some embodiments, after the post-sampling data 220 has finished accumulating, for example at the end of image data sampling, a first accumulated portion 215 for a next image frame may begin to be stored in the memory 140. The first accumulated portion 215 for the next image frame may be accumulated until the acquisition signal is next received, at which point the image sensor 100 may treat it as a pre-sampling data 210 for the next image frame. The image sensor 100 may acquire the image data for the next frame while accumulating a next second accumulated portion 225, and may arrange and transmit the next image frame including the next pre-sampling data 210, next image data, and next post-sampling data 220, and so on for subsequent image frames.

Referring to FIG. 3, in some embodiments the post-sampling data 220 may be included withing one or more rows of pixel data, for example appended to the end of one or more rows of image data 200. For example, the post-sampling data 220 may be partitioned based on one or more line valid acquisition signals. More generally, the image data 200 may include multiple data segments (e.g., pixel rows, pixels, section, or the like) and the post-sampling data from the external sensor 170 may be interleaved between one or more of the data segments.

For example, the portion of the post-sampling data 220 accumulated during acquisition of each pixel row may be included as additional data at the end of the corresponding pixel row by the output circuitry 120. For example, the external sensor data may be temporarily stored in the memory 140 during acquisition of each pixel row, and upon completion of sampling of a pixel row (e.g., in relation to a line valid signal) the accumulated audio data may be obtained from the memory 140 and appended 220-1, 220-2, . . . , 220-N to the end of the sampled pixel row data. Therefore, the post-sampling data 220 may include the additional pixel data 220-1, 220-2, . . . , 220-N included with each pixel row prepare and provided by the output circuitry 120.

For example, for an external sensor data 175 comprising a PDM microphone operating at 1 MHz and providing a single bit of data every 1 μs, if a pixel row of image data 200 requires 10 μs to be sampled then the image sensor 100 will accumulate 10 bits of audio data for each pixel row sampled. The output circuitry 120 may obtain the accumulated 10 bits of audio data from the memory 140 upon completion of sampling a pixel row and may include it, for example as additional pixel data 220-1, 220-2, . . . , 220-N, at the end of the pixel row. Continuing with this example, for pixel data encoded at 12 bits per pixel, the output circuitry 120 will only be required to add one additional pixel's worth of data at the end of each pixel row. In some such embodiments, the memory 140 usage may be kept very low due to incoming external sensor data 175 being (almost) immediately read out.

Other exemplary embodiments may include both the pre-sampling data 210 and the post-sampling data 220 partitioned among the various pixel data, for example at a beginning and end of a pixel row, at even and odd pixel rows, and predefined locations within the image data 200, and/or the like. It will be understood that various other configurations of arranging image data 200, pre-sampling data 210, and post-sampling data 220 may be used, with the pre-sampling data 210 and post-sampling data 220 identifiable based on their position(s) with respect to the image data 200. Further, it will be understood that only two of the image data 200, pre-sampling data 210, and post-sampling data 220 need to be associated with the third of such data in order to extract the synchronized sensor data.

In some embodiments, the output circuitry 120 may arrange the image data 200, pre-sampling data 210, and post-sampling data 220 as data packets. The output circuitry 120 may identify the pre-sampling data 210 and post-sampling data 220 using a tag, header information, footer information, or the like, and may identify with which packet of image data 200 the respected pre-sampling data 210 and post-sampling data 220 are associated with. In some embodiments, the output circuitry 120 may identify the pre-sampling data 210 packet and post-sampling data 220 packet by the transmission order of the respective packets, for example the order with respect to one or more packets of image data 200.

In some embodiments, each row of image data 200 may be a separate data packet, the pre-sampling data 210 may be transmitted prior to transmission of any image data 200 packets, and the post-sampling data 220 may be transmitted after transmission of all image data 200 packets (e.g., with respect to FIG. 2) or as a data packet after transmission of each image data 200 packet (e.g., with respect to FIG. 3). In some embodiments, the pre-sampling data 210 may be a specified virtual channel, data type, or the like, and the post-sampling data 220 may be a specified virtual channel, data type, or the like. For example, the pre-sampling data 210 and/or post-sampling data 220 may have predetermined data type associated with its position in the data stream that a receiving device can use to unpack the data, interpret the data, separate the data, or the like.

It will be understood that transmitting one data before or after another may include adjacent or otherwise proximate transmissions, but may not require transmitting one data immediately before/after the other data. In addition, while the associated sensor data may be synchronized based on various arrangements of the data, for example as described above, the actual acts of packaging and transmitting the respective data by the output circuitry 120 need not be synchronized with the sensor data acquisition.

In some embodiments, if the image sensor 100 is operating at a faster framerate having little or no space between the image frames 230, the pre-sampling data 210 accumulation will remain relatively small, and the post-sampling data 220 accumulation during sampling of the image data 200 will remain relatively small. If the image sensor 100 is operating at a slower framerate having more time between image frames 230, the amount of accumulated pre-sampling data 210 may be sufficiently small to use an existing additional frame buffer, for example normally used for later frames. It will be recognized that many suitable memory 140 arrangements exist for storing pre-sampling data 210, image data 200, and post-sampling data 220.

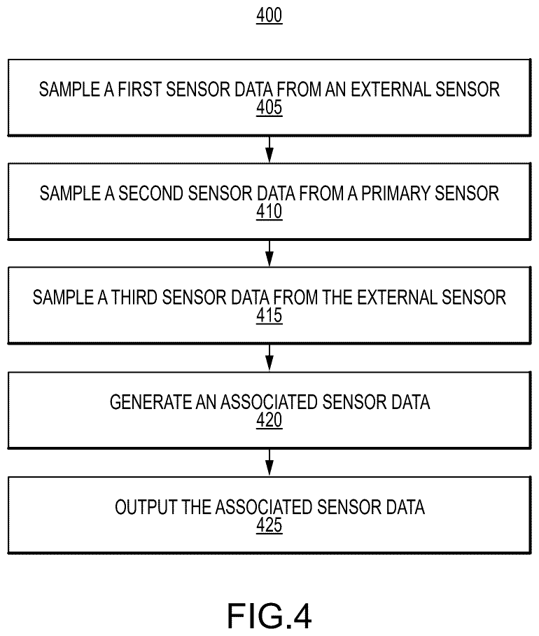

FIG. 4 is a flowchart illustrating an exemplary method for synchronizing multi-sensor output 400. The method for synchronizing multi-sensor output 400 may be performed by the image sensor 100, for example implemented by the output circuitry 120 and/or related circuitry, using the memory 140, and/or the like. More generally, the method for synchronizing multi-sensor output 400 may be performed by a primary sensor device receiving sensor data from an auxiliary sensor device, and the acquisition signal may be at a known or knowable point in time, whether absolute or relative (e.g., offset), with respect to the process of sampling the primary sensor data.

At step 405, the primary sensor device, for example the image sensor 100, may receive a first sensor data from an auxiliary sensor device, for example from an external sensor 170. In some embodiments, the external sensor 170 may include a microphone and the external sensor data 175 may include audio data. Receiving the first sensor data may include storing the external sensor data 175, for example in a memory 140. The external sensor data 175 may be received and stored as the first sensor data until an acquisition signal is received, until the pixel array 110 begins sampling, or other suitable synchronization point.

At step 410, the primary sensor device may sample a second sensor data from the primary sensor device. In some embodiments, the primary sensor device may include an image sensor 100 having a pixel array 110 and the second sensor data may include image data. Sampling the second sensor data may be performed in synchronization with an acquisition signal, for example a trigger, valid signal, or the like.

At step 415, the primary sensor device may receive a third sensor data from the auxiliary sensor device. Receiving the third sensor data may include storing the external sensor data 175, for example in the memory 140. The external sensor data 175 may be received and stored as the third sensor data in response to receiving an acquisition signal, when the pixel array 110 begins sampling, or other suitable synchronization point. In some embodiments, the external sensor data 175 may be received and stored as the third sensor data during the sampling of the primary sensor device and until the sampling of the primary sensor device has completed.

At step 420, the primary sensor device may generate an associated sensor data. In some embodiments, step 420 may include identifying the first sensor data as pre-sampling data and identifying the third sensor data as post-sampling data. In some embodiments, identifying the first sensor data as pre-sampling data may include storing, for example in a memory 140, the first sensor data for output prior to output of the second sensor data. In some embodiments, identifying the first sensor data as pre-sampling data may include outputting the first sensor data prior to the second sensor data.

Likewise, in some embodiments, identifying the third sensor data as post-sampling data may include storing, for example in a memory 140, the third sensor data for output subsequent to output of the second sensor data. In some embodiments, identifying the third sensor data as post-sampling data may include outputting the third sensor data subsequent to the second sensor data. In other exemplary embodiments, the second sensor data may include segmented sensor data, such as multiple pixel rows, and identifying the third sensor data as post-sampling data may include storing and/or transmitting the third sensor data as interleaved with the second sensor data. For example, identifying the third sensor data as post-sampling data may include appending accumulated external sensor data 175 as data at the end of one or more pixel rows of image data.

In some embodiments, identifying the first sensor data as pre-sampling data may include generating a first data packet for the first sensor data and identifying the first data packet as the pre-sampling data, for example through header/footer information, transmission ordering, and/or the like. In some embodiments, the image data may be included in a second data packet. In some embodiments, identifying the third sensor data as post-sampling data may include generating a third data packet for the third sensor data and identifying the third data packet as the post-sampling data, for example through header/footer information, transmission ordering, and/or the like.

At step 425, primary sensor device may output the arranged first sensor data, second sensor data, and third sensor data, for example as associated sensor data. In some embodiments, the output circuitry 120 of the image sensor 100 may output the associated sensor data over a sensor output 150. The sensor output 150 may be any suitable communication interface, for example a serial interface, parallel interface, may use any suitable communication protocol, and/or the like. The associated sensor data may be provided to another system or device which is configured to extract the first, second, and third sensor data from the associated sensor data and to reconstruct the sensor data from the auxiliary sensor synchronized with the primary sensor data.

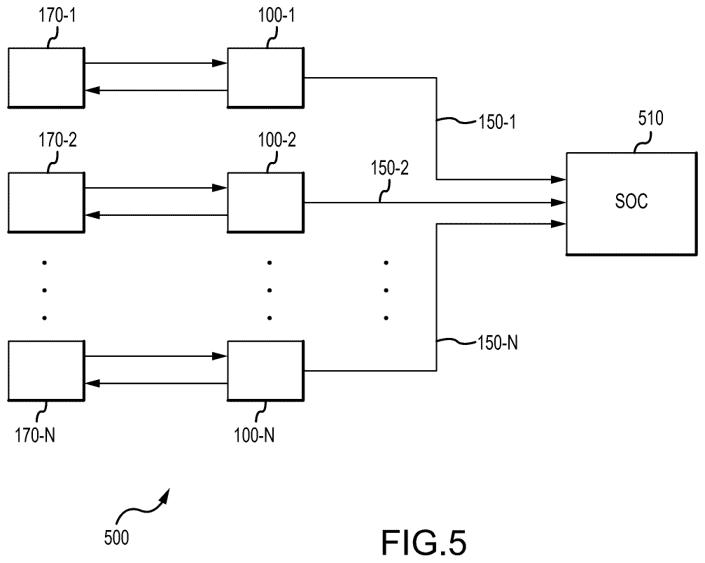

FIG. 5 illustrates an exemplary multi-sensor system 500. In some embodiments, the multi-sensor system 500 may include an application processor 510 adapted to receive sensor data from one or more sensing devices. The application processor 510 may include any suitable systems or methods configured to process received sensor data and to further analyze, perform actions, make determinations, or the like based on the received sensor data. For example, the multi-sensor system 500 may include a vehicle surround-view system, and the application processor 510 may include a system-on-chip (SoC), electronic control unit (ECU), and/or or other processing device of the vehicle. In some embodiments, the application processor 510 may provide the trigger 160 to the one or more primary sensor devices.

The multi-sensor system 500 may include one or more primary sensor devices, each of which may receive and arrange sensor data from one or more auxiliary sensor devices. In some embodiments, for example in surround view applications, the multi-sensor system 500 may include one or more image sensors 100-1, 100-2, . . . , 100-N, each of which may receive external sensor data 175 from a respective external sensor 170-1, 170-2, . . . , 170-N. The external sensors may include microphone devices, such as PDM microphones. Each of the image sensors 100-1, 100-2, . . . , 100-N may be configured to receive the respective external sensor data 175-1, 175-2, . . . , 175-N, create the respective associated sensor data including pre-sampling data, image data, and post-sampling data, and provide the respective associated sensor data on the sensor outputs 150-1, 150-2, . . . , 150-N.

The application processor 510 may be configured to receive each of the associated sensor data from each of the image sensors 100-1, 100-2, . . . , 100-N, for example according to the same communication protocol used by the image sensors. In some embodiments, the application processor 510 may include a SERDES device. Because the auxiliary sensor device data (pre- and post-sampling) is stored in a known arrangement within each image frame, is tagged appropriately in a virtual channel and/or as a data packet, and/or the like, the auxiliary sensor device data is synchronized to a video timing construct without creating separate timestamps, master clock, or other timing tags which need to then be applied. The application processor 510 may therefore be configured to reconstruct the sensor data from the auxiliary sensor devices and the sensor data from the primary sensor devices, without required additional time stamp circuitry, MPEG decoding, and/or the like.

For example, in some embodiments, the application processor 510 may separate the incoming data from each output 150-1, 150-2, . . . , 150-N into pre-sampling audio data, image data, and post-sampling audio data. Because the associated sensor data is synchronized with respect to the image data, the resulting reconstructed audio data is synchronized with the image data. In some embodiments, the post-sampling data may be synchronized row-by-row (e.g., according to FIG. 3), may be synchronized to an entire image data (e.g., according to FIG. 2), or the like. In some embodiments, the application processor 510 may resolve the timeline of audio and image data via the order of the received sensor data.

For further example, a surround view system according to the embodiments described herein will automatically have all audio samples synchronized to a same trigger, or that self-generated audio and video data are tied to the same a same point in time within a given sample accuracy. For example, if the external sensor 170-1, 170-2, . . . , 170-N are PDM microphones, the same accuracy will be about 1 μs for a PDM operating at 1 MHz, will be about 200 ns for a PDM operating at 5 MHz, will be about 2 μs for a PDM operating at 500 kHz, and the like.

In some embodiments, the synchronized audio delivery to the application processor 510 allows for phase and amplitude analysis of the audio data from the multiple microphones to identify directionality or location of a sound source, such as a siren, road hazard, rumble strip, vehicle malfunction, and/or the like.

Additional processing on the synchronized audio data streams may be performed to determine if a sound, such as a siren, is coming toward a vehicle or moving away, for example by determining a doppler shift. In some embodiments, the synchronized audio and video streams from the image sensors 100-1, 100-2, . . . , 100-N may be analyzed together in a multi-modal sensing application to observe events such as vandalism, intrusion, cries of distress, and/or the like. Other exemplary use cases may include robo-taxis to observe someone hailing a taxi, analyzing a loud noise such as from a popped tire, backfire, engine trouble, engine braking, identification or confirmation of a flat tire, and/or the like. Other analysis may identify accidents involving a vehicle, skidding, may anticipate pedestrians for example by analyzing “walk,” “wait,” beeping, or other sounds at a crosswalk, may detect truck backup. Additional analysis may detect vehicle service required such, for example observing brake squeal, bearing damage, ball joint damage, including location on the vehicle of such repairs needed. Additional analysis may also detect driving habits or road guides such as rumble strip ingress, stop strips, and/or other driver aids or signals.

In some such embodiments, it may be sufficient to have a relative synchronization of audio and/or video data instead of an absolute synchronization. For example, for determining phase information related to the audio data, it may be sufficient to have all audio signals correlated in time, even if they are slightly misaligned to a frame valid or other acquisition signals.

In general, the interleaving of the auxiliary sensor data with the primary sensor data creates an accurate time relationship compared to trying to synchronize two independent processing systems. Because the application processor 510 is able to understand the timing of the various sensor data streams from the primary sensor devices and the auxiliary sensor devices, it is able to analyze the respective sensor data in any number of ways and for any number of purposes.

Various embodiments therefore provide systems, devices, and methods that synchronize multiple sensor data without the need for additional clock signals, complicated codecs, and/or the like. Various embodiments may provide a cost reduction due to the integration of the audio interface into the imager, and may provide increased efficiency and effectiveness. The benefits may be achieved with minimal impact to manufacturing cost, circuity size, and the like.

Various embodiments use an external trigger or internal valid signal to synchronize the audio to video and audio to audio. Such synchronization allows for video/audio analysis such as providing additional context for the video (e.g., car accident, person hailing a cab, and the like), and for audio/audio analysis (e.g., triangulation of siren using amplitude and phase, direction of siren/noise, and the like). Various embodiments may provide such advantages without requiring a presentation time stamp or reference clock. This synchronized functionality exceeds the capability of the independent sensing analysis that is currently available.

The arrangement of the image sensor 100 described herein is merely illustrative. In general, any desired memory 140, pixel array 110, pixel circuitry, or the like may be used with the output circuitry 120. The systems and methods described herein may be used in an image sensor that operates with a rolling shutter (in which each row of pixels sequentially captures an image) or a global shutter (in which every pixel in the image sensor simultaneously captures an image). The systems and methods described herein may be suitably adapted for use with sensing modalities different from the image sensors and microphones representatively illustrated herein. In some embodiments, the external sensor data 175 may be a sensor device that is included within, instead of external from, the primary sensing device. The primary sensing device may be the sensing device that receives the additional sensor data, arranges it with its own sensor data, and outputs the associated sensor data.

The various components and functions shown and described with respect to the process flows and image sensor may be distributed amongst the various components of the image sensor 100 and/or external systems in any manner, and different embodiments may organize the processing of various features and information in any number of different ways. Several of the various features and systems described herein may be implemented in software and/or firmware that resides in non-transitory data storage for execution by one or more processors to perform the various (automated) processes described herein. For example, the output circuitry 120 and/or the method for synchronizing multi-sensor output 400 may be implemented using a processor, transistor logic, a field programmable gate array (FPGA), state machine, and/or the like.

It will be recognized that various circuitry described herein may alternatively or additionally be implemented as computer instructions (software, firmware, or the like) configured to cause a processor to perform the functions of the described circuitry. It will also be recognized that computer instructions and/or automated processes described herein may alternatively or additionally be implemented as hardware circuitry operable to perform the functions of the described computer instructions. The term “data” as used herein may refer to a single piece of information, for example a single digital bit, and/or may refer to multiple pieces of information.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations can exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method for synchronizing multi-sensor output, comprising:
sampling, by a first sensor device, a first sensor data;
receiving, by the first sensor device, a second sensor data from a second sensor device prior to the sampling of the first sensor data;
receiving, by the first sensor device, a third sensor data from the second sensor device during the sampling of the first sensor data;
creating, by the first sensor device, an associated sensor data, comprising associating the first sensor data with the second sensor data and the third sensor data; and
outputting, by the first sensor device, the associated sensor data.

2. The method of claim 1, wherein:
creating the associated sensor data comprises:
identifying the second sensor data as a pre-sampling data; and
identifying the third sensor data as a post-sampling data; and
sampling the first sensor data is performed in synchronization with an acquisition signal.

3. The method of claim 2, wherein:
the first sensor device comprises an image sensor;
the first sensor data comprises an image data;
the second sensor device comprises a microphone; and
the second sensor data comprises a first audio data and the third sensor data comprises a second audio data.

4. The method of claim 3, wherein identifying the second sensor data as the pre-sampling data comprises storing, in a memory of the image sensor, the first audio data for output prior to output of the image data.

5. The method of claim 4, wherein identifying the third sensor data as the post-sampling data comprises storing, in the memory, the second audio data for output subsequent to the output of the image data.

6. The method of claim 4, wherein:
the image data comprises a plurality of rows of pixel data; and
identifying the third sensor data as the post-sampling data comprises storing, in the memory, the second audio data for interleaved output with the plurality of rows of pixel data.

7. The method of claim 3, wherein:
identifying the second sensor data as the pre-sampling data comprises:
generating a first data packet comprising the first audio data; and
identifying the first data packet as the pre-sampling data;
identifying the third sensor data as the post-sampling data comprises:
generating a second data packet comprising the second audio data; and
identifying the second data packet as the post-sampling data; and
outputting the associated sensor data comprises transmitting the associated sensor data as separate data packets including the first data packet, the second data packet, and a third data packed comprising the image data.

8. The method of claim 1, wherein:
the first sensor data comprises a plurality of sequential data segments; and
associating the first sensor data with the third sensor data comprises arranging the third sensor data between at least two sequential data segments of the first sensor data.

9. An image sensor, comprising:
a pixel array adapted to generate an image data;
an input adapted to receive a plurality of sensor data from a second sensor device;
a memory adapted to store at least some of the plurality of received sensor data; and
an output circuitry adapted to:
retrieve a first sensor data from the memory in response to an acquisition signal, wherein the first sensor data is received from the second sensor device prior to the acquisition signal;
acquire the image data in synchronization with the acquisition signal;
retrieve a second sensor data from the memory, wherein the second sensor data is received from the second sensor device while acquiring the image data; and
transmit the first sensor data, the image data, and the second sensor data, comprising:
identifying the first sensor data as a pre-sampling sensor data; and
identifying the second sensor data as a post-sampling sensor data.

10. The image sensor of claim 9, wherein identifying the first and the second sensor data comprises transmitting the first sensor data, the image data, and the second sensor data in a predetermined order.

11. The image sensor of claim 10, wherein:
identifying the first sensor data comprises transmitting the first sensor data prior to transmitting the image data; and
identifying the second sensor data comprises transmitting the second sensor data subsequent to transmitting the image data.

12. The image sensor of claim 10, wherein:
identifying the first sensor data comprises transmitting the first sensor data prior to transmitting the image data; and
identifying the second sensor data comprises transmitting the second sensor data interleaved with the image data.

13. The image sensor of claim 12, wherein transmitting the second sensor data interleaved with the image data comprises including the second sensor data at an end of at least one pixel row of the image data.

14. The image sensor of claim 9, wherein:
identifying the first sensor data comprises:
generating a first data packet comprising the first sensor data; and
identifying the first data packet as the pre-sampling sensor data; and
identifying the second sensor data comprises:
generating a second data packet comprising the second sensor data; and
identifying the second data packet as the post-sampling sensor data.

15. The image sensor of claim 9, wherein:
the second sensor device comprises a microphone; and
the first sensor data comprises a first audio data and the second sensor data comprises a second audio data.

16. The image sensor of claim 15, further comprising an output adapted to provide a clock signal to the second sensor device, wherein the input receives the sensor data from the second sensor device in response to the provided clock signal.

17. A sensor device, comprising:
a sensing apparatus adapted to periodically generate a first sensor data based on received stimuli;
an input adapted to receive a plurality of second sensor data from an external sensor device;
a memory adapted to store the plurality of second sensor data; and
an output circuitry adapted to:
retrieve a first set of the plurality of second sensor data from the memory in response to a periodic generation of the first sensor data, wherein the first set is received from the external sensor device prior to the periodic generation;
retrieve a second set of the plurality of second sensor data from the memory, wherein the second set is received from the external sensor device during the periodic generation; and
transmit an associated sensor data comprising the first set of second sensor data, the generated first sensor data, and the second set of second sensor data.

18. The sensor device of claim 17, wherein the associated sensor data comprises:
the first set of second sensor data identified as a pre-sampling sensor data; and
the second set of second sensor data identified as a post-sampling sensor data.

19. The sensor device of claim 18, wherein the output circuitry is further configured to:
retrieve a third set of the plurality of second sensor data from the memory, wherein the third set of second sensor data is received from the external sensor device subsequent to the periodic generation and prior to a second periodic generation of first sensor data.

20. The sensor device of claim 19, wherein:
the sensing apparatus comprises an image sensor configured to transmit the associated sensor data in a first image frame; and
the output circuitry is configured to generate a second image frame related to the second periodic generation, wherein the second image frame comprises the third set of second sensor data identified as a pre-sampling sensor data.
